(19) United States
(12) Patent Application Publication
(10) Pub. No.: US 2020/0240551 A1
(43) Pub. Date: Jul. 30, 2020

(54) MULTIPLE PIPE BRACKET

(71) Applicant: TransGard LLC, York, PA (US)

(72) Inventors: Ryan Escure, York, PA (US); William Reichard, York, PA (US)

(21) Appl. No.: 16/740,836

(22) Filed: Jan. 13, 2020

Related U.S. Application Data
(60) Provisional application No. 62/798,796, filed on Jan. 30, 2019.

(51) Int. Cl. F16L 3/233; F16L 3/04

(52) U.S. Cl. CPC F16L 3/233; F16L 3/04

(57) ABSTRACT

A pipe bracket may be used to secure a plurality of pipes to each other and a substrate, such as the ground. The bracket has a mounting arm having a hole for receiving a fastener. The mounting arm extends between a first free end and a corner. The bracket also has a pipe holding section. The pipe holding section has a stationary end, a flexible end, and a connecting member. The pipe holding section extends from the corner to a second free end at the flexible end. The connecting member includes a first radius section, a second radius section, and a flat bridge such that the pipe holding section defines a containment area for the plurality of pipes having an oblong shape. The mounting arm extends in a plane that is parallel to the substrate.

### CROSS-REFERENCE TO RELATED APPLICATIONS

This application claims the benefit of priority of U.S. Provisional Patent Application No. 62/798,796, filed on Jan. 30, 2019, the entire contents of which are hereby incorporated by reference herein.

### TECHNICAL FIELD

This disclosure relates to a bracket for holding pipes. More particularly, this disclosure relates to a bracket for holding multiple parallel pipes laying or extending in the same direction.

### BACKGROUND

There are many situations in which it may be required to secure two or more pipes in close proximity or in a touching arrangement with each other. In the field of perimeter fencing, for example, any gap between materials provides a place for an animal to penetrate the perimeter. The area where pipes or posts come together may be a source of such gaps. As in the case of lay flat barrier fencing such as disclosed in the provisional patent application entitled Small Animal Deterrent Barrier, by Ryan Escure (Attorney Docket No. 146626.00300) and filed concurrently herewith, it is important to secure the panels together but also to the ground to eliminate a gap to the ground and also to resist winds, especially hurricane force winds. The bracket described herein solves those and other needs.

### SUMMARY

Some embodiments provide a pipe bracket configured to hold two or more adjacent pipes in touching arrangement along a common length. The pipe bracket includes a mounting arm and a pipe holding section. The pipe holding section is defined by a stationary end, a flexible end, and a connecting member. The pipe holding section is configured to hold two or more pipes in touching arrangement and under tension provided by the flexible end.

Some embodiments provide a pipe bracket for securing a plurality of pipes to a substrate, such as the ground. The pipe bracket includes a mounting arm including a hole for receiving a fastener. The mounting arm extends between a first free end and a corner. The pipe bracket also includes a pipe holding section including a stationary end, a flexible end, and a connecting member. The pipe holding section extends from the corner to a second free end at the flexible end. The connecting member includes a first radius section, a second radius section, and a flat bridge such that the pipe holding section defines a containment area having an oblong shape. The mounting arm extends in a plane that is parallel to the substrate such that the substrate closes-off the containment area when the bracket is attached to the substrate.

Some other embodiments provide a barrier. In some embodiments, the barrier includes a first module including a first end pipe and a second module including a second end pipe. The barrier further includes a bracket configured to secure the first end pipe to the second end pipe and a substrate. The bracket includes a mounting arm and a pipe holding section defined by a stationary end, a flexible end, and a connecting member. The pipe holding section is configured to hold the first end pipe and the second end pipe in touching arrangement and under tension provided by the flexible end.

These and other variants will be appreciated by those of skill in the art upon reading the description below.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures.

FIG. 1 is a perspective view of a portion of an exemplary small animal deterrent barrier, according to an embodiment;

FIG. 2 is a perspective view of a pipe bracket and pipe combination that may be used in conjunction with the small animal deterrent barrier, according to an embodiment.

FIG. 3 is a top view of the pipe bracket and pipe combination;

FIG. 4 is a perspective view of an exemplary pipe bracket, according to an embodiment;

FIG. 5 is a front view of the pipe bracket;

FIG. 6 is a top view of the pipe bracket;

FIG. 7 is a side view of the pipe bracket;

FIG. 8A is a front view of a pipe bracket, according to another embodiment;

FIG. 8B is a close up view of a first stepped-radius section of the pipe bracket of FIG. 8A;

FIG. 8C is a close-up view of a second stepped-radius section of the pipe bracket of FIG. 8A; and

FIG. 9 is a front view of a pipe bracket, according to yet another embodiment.

### DETAILED DESCRIPTION

The present disclosure describes a barrier comprised of multiple pipes. At least two of the pipes may be arranged adjacent to each other and in a parallel orientation along their longitudinal lengths. These pipes may be secured to each other and a substrate through a bracket. The bracket thus may be configured as an anchor to secure the pipes in a lay-flat configuration to the substrate, such as the ground. The bracket described herein is configured to hold two or more adjacent pipes in alignment with each other such that adjacent pipes are substantially in position parallel to each other along their longitudinal lengths. For example, the adjacent pipes may be held in contact with each other along their common lengths. In one embodiment, the side walls of each pipe rest in contact with an adjacent pipe's sidewall, thereby minimizing any gap between each pipe. The bracket can be firmly attached to a substrate (wall, ground, framing, etc.) with a solid backing so that the pipes do not slip out. In some applications, the bracket is useful for securing perimeter fencing or lay-flat animal deterrent barrier fencing.

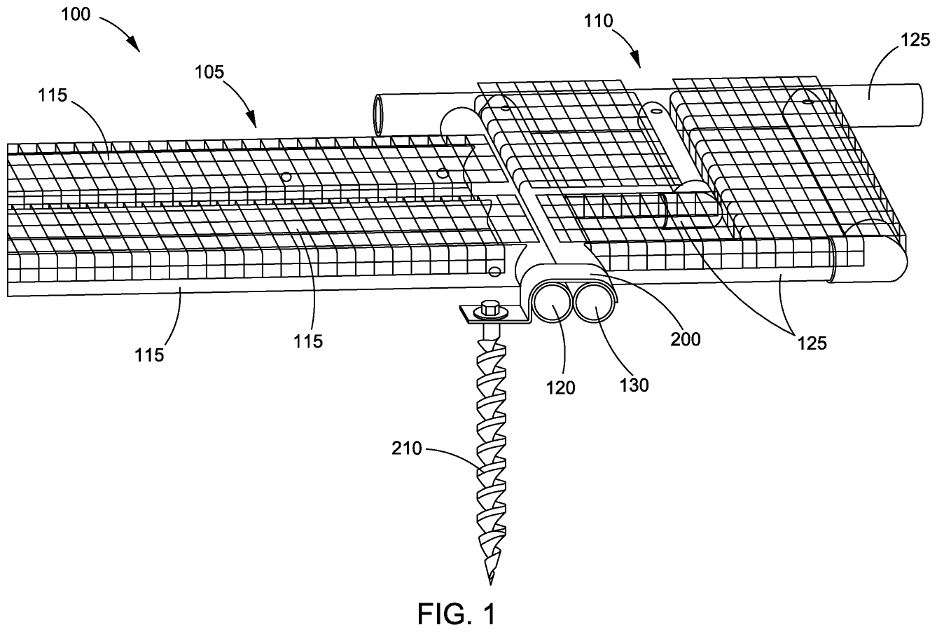

FIG. 1 depicts an exemplary barrier 100. The barrier 100 is configured to lay flat with respect to a ground surface, but embodiments are not limited thereto. An exemplary embodiment of the barrier 100 is described in the concurrently-filed provisional patent application entitled Small Animal Deterrent Barrier by inventor Ryan Escure (Attorney Docket No. 146626.00300), the contents of which is hereby incorporated by reference in its entirety. The barrier 100 may include different modules 105, 110. The module 105 and module 110 are adjacent to each other and are made up of interconnected pipes. For example, the first module 105 may include pipes 115 connected to an end pipe 120, and the second module 110 may include pipes 125 connected to an end pipe 130. The end pipes 120 and 130 are secured to one another such that adjacent modules 105, 110 are connected to each other to create a combined-module barrier. The end pipes 120 and 130 are aligned along their common lengths in a touching arrangement to eliminate any space through which a small animal could pass. As used herein, touching arrangement refers to the end pipes 120, 130 being held in contact with one another. In other embodiments a spacer may be in common contact between the pipes 120, 130.

The barrier 100 further includes a bracket 200 configured to connect the end pipes 120 and 130 to each other in touching arrangement and to secure the barrier 100 to the ground or other base surface. The bracket 200 thus holds modules 105 and 110 to each other and secures the barrier 100 in place on the ground. To secure the barrier 100 against movement and high winds, a fastener 210 may be used in conjunction with the bracket 200. Those of skill in the art will recognize a variety of fasteners may be used, and will be chosen based on numerous factors, including but not limited to the substrate type (e.g., sandy soil, loose soil, compacted soil, concrete, asphalt, gravel, etc.). The exemplary fastener 210 may be threaded and configured to be inserted into the ground to hold the bracket 200 (and thus the barrier 100) in place.

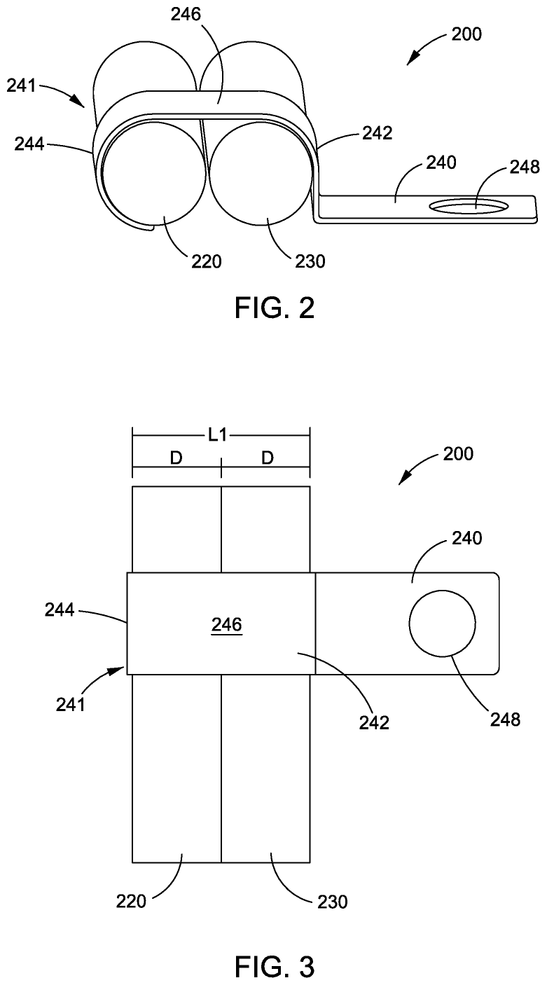

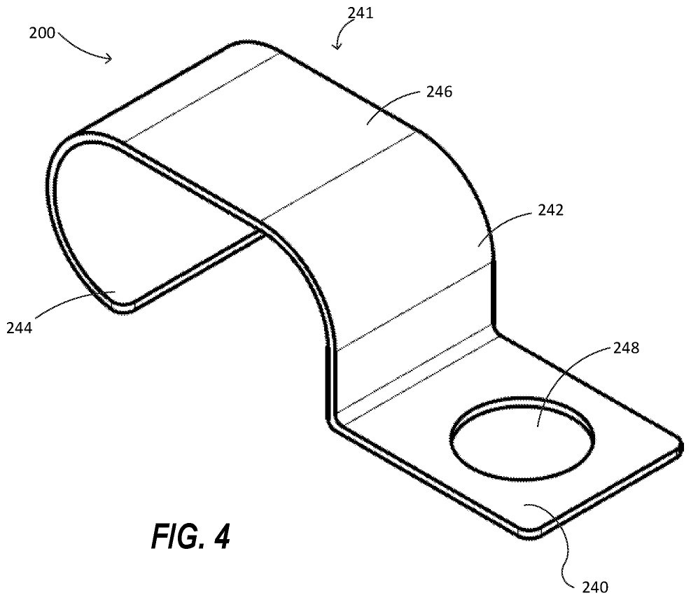

FIGS. 2 and 3 further depict the bracket 200 for holding two adjacent pipes 220, 230 of substantially the same diameter D. FIG. 4 is a perspective view of the pipe bracket 200 by itself. The bracket 200 comprises a mounting arm 240, and a pipe holding section 241 which defines a stationary end 242 and a flexible end 244 and a connecting member 246 therebetween. As shown, the mounting arm 240 defines a hole 248 for accepting the fastener 210.

The pipe holding section 241 is designed and configured to apply pressure to the pipes 220, 230 held between the flexible end 244 and the stationary end 242. In one embodiment, the length L1 between the stationary end 242 and the flexible end 244 is approximately equal to the sum of the diameters D when the pipes 220, 230 are held in the bracket 200. However, when the pipes 220 and 230 are not in the pipe holding section 241 (e.g., see FIG. 6), a length L2 between the stationary end 242 and the flexible end is less than the length of the combined diameters D of the adjacent pipes. For example, L2 may be slightly less than two times the diameter D (and thus slightly less than L1). Were there three pipes, L2 would be slightly less than three times the diameter D. Due to its flexible nature, however, the flexible end 244 may expand to L1 accept the full diameter D of the pipes 220, 230, under tension, thereby keeping them in place and in touching arrangement (e.g., see FIGS. 2-3). As shown, the flexible end 244 has a curved shape approximating the curvature of the pipes 220, 230 to be held.

The pressure exerted on the first pipe 220 pushes it into touching arrangement with the second pipe 230. In other embodiments, a continuous spacer may be held between the first pipe 220 and second pipe 230 through the pressure exerted by the bracket 200. Through the use of one or multiple brackets 200, the touching arrangement can be maintained substantially along the entire common length of the adjacent pipes 220, 230.

Any diameter pipe may be accommodated simply by changing the dimensions of the bracket 200 when fabricating the bracket 200. In some embodiments, the diameters of the pipes to be joined are the same or similar. In other embodiments, a bracket may be configured for pipes of different diameters. The dimensions of the bracket 200 may be adjusted accordingly, and the length L of the bracket will not be the sum of the diameters, since the pipes will not necessarily make contact at each pipe's widest point. The concept, however, remains the same; the pipes are held together along their lengths under tension and to a substrate such as the ground by a fastener holding the bracket 200 to the substrate.

In some embodiments, the bracket is a one piece construction. Any suitable material may be used having the appropriate balance of rigidity in the mounting arm and stationary end and flexibility in the flexible end. Materials such as metals and plastics are ideally suited. The brackets are contemplated particularly for maintaining modular electrical fence panels in close proximity to one another. In some embodiments, the bracket is made of non-conductive material to avoid electrifying the pipes themselves or the surrounding area to which the bracket is secured. In most instances, placement will prevent the brackets themselves from being electrified, but using non-conductive materials is an added safety feature.

Although the tension provided by the flexible end may be enough to hold the pipes in place, additional fasteners, such as screws, nails, spikes, tape, adhesive, detents, projections, or the like may be used to secure the bracket to one or more of the pipes, or one or more of the pipes to another pipe.

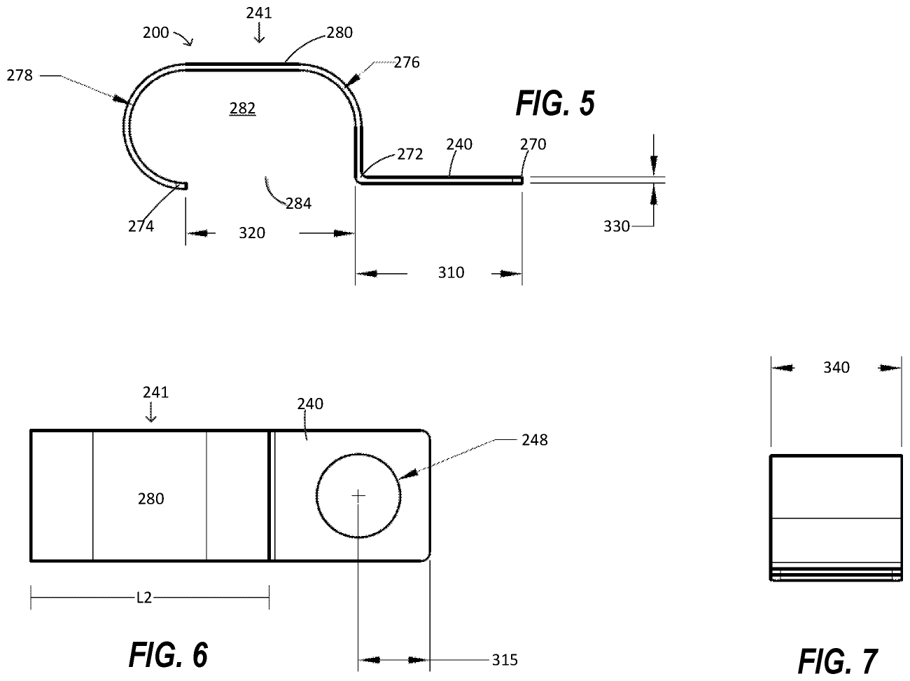

FIGS. 5-7 further illustrate additional details of the exemplary pipe bracket 200. As shown, mounting arm 240 extends from a free end 270 to a corner 272 at which point the bracket 200 transitions into the pipe holding section 241. The pipe holding section 241 extends from the corner 272 (i.e., the stationary end 242) to a second free end 274 (i.e., the flexible end 244) via the connecting member 246 therebetween. In an exemplary embodiment, the connecting member 246 is shaped such that it includes a first radius section 276, a second radius section 278 and a flat bridge 280 connecting the radius sections 276, 278. In the embodiment shown, the pipe holding section 241 thus forms a containment area 282 having an oblong shape.

The pipe bracket 200 may include dimensions that enable the bracket 200 to be securely held to the substrate (e.g., the ground) via the mounting arm 240 while also securing multiple pipes within the space defined by the pipe holding section 241. The mounting arm 240 includes a length 310 from the free end 270 to the corner 272. The mounting arm 240 may also define a length 315 from the free end 270 to a center of the hole 248. The lengths 310 and 315, along with the size of the hole 248, may be sufficient to create a large enough surface for a secure mounting to a substrate. For example, the length 310 may be approximately 3.5″, the length 315 may be approximately 1.5″, and the diameter of the hole 248 may be approximately 1.75″.

The bracket 200 may be configured to hold the pipes 220, 230 against a substrate via the mounting arm 240 and the fastener 210. The mounting arm 240 may be configured to extend in a plane that is parallel to the substrate and the pipe holding section 241 may be arranged to pin the pipes 220, 230 against the substrate or at least close-off the containment area 282. For example, an opening 284 into the containment area 282 may be adjacent to the mounting arm 240 such that the substrate closes-off the containment area 282 when the bracket is connected to the substrate. For example, the opening 284 may be approximately in the same plane as the mounting arm 240. The hole 248 is formed such that an axis thereof is perpendicular to the direction in which the pipes 220, 230 are adjacent to each other and a longitudinal extent of the pipes 220, 230.

In an exemplary embodiment, the pipe holding section 241 may be dimensioned to accept two approximately 2″ PVC pipes within the space defined between the stationary end 242 and the flexible end 244. For example, the first radius section 276 may be a one-quarter circular section and have a radius of approximately 1.188″. The second radius section 278 may be a one-half circular section and also have a radius of approximately 1.188″. A distance 320 from the corner 272 to the free end 274 may be approximately 3.563″. The pipe bracket 200 may further include a material thickness 330 of approximately 0.125″ and a width 340 of approximately 2.75″. In another embodiment, the material thickness 330 may be approximately 0.20″ and the material may be steel.

It should be understood that the provided dimensions are exemplary and may be adjusted to accommodate different sizes, shapes, or amounts of pipes. Moreover, the dimensions are approximate and may be adjusted within a 10% range while maintaining proportions in one embodiment. Other embodiments may have different dimensions and proportions depending on the application.

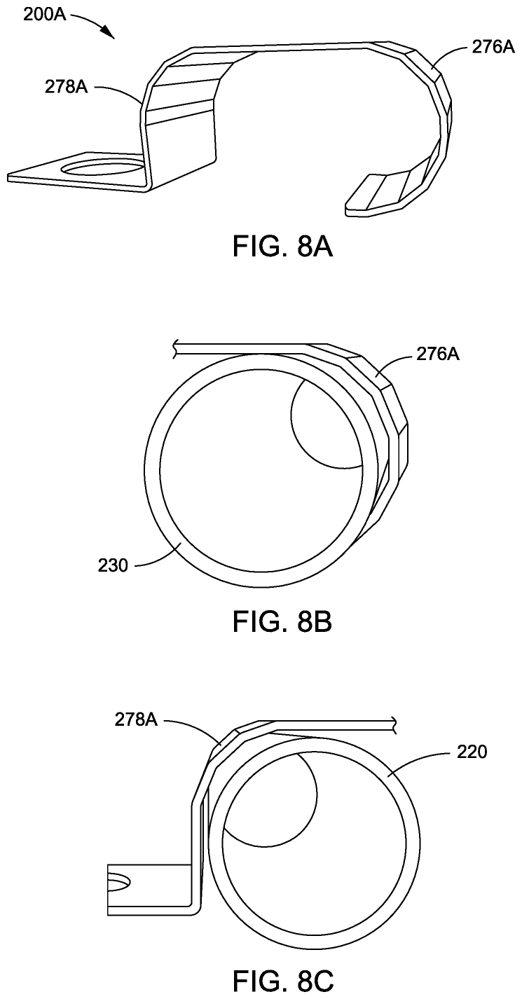

FIGS. 8A-8C are drawings of an alternative embodiment of a bracket 200A. The bracket 200A may include all of the features of the bracket 200, with alternative stepped-radius sections 276A and 278A in place of the radius sections 276, 278. The stepped-radius sections 276A, 278A may define an uneven radius through a series of substantially linear segments. The bracket 200A may be formed through a series of bends to form the stepped-radius sections 276A, 278A. The stepped configuration of the sections 276A, 278A may produce a series of contact surfaces separated by gaps at the bend points, as seen in FIGS. 8B and 8C. These contact surfaces may help to allow the bracket 200A to accommodate different sizes of pipes 220, 230 by providing spaced-apart contact areas instead of a single curved surface.

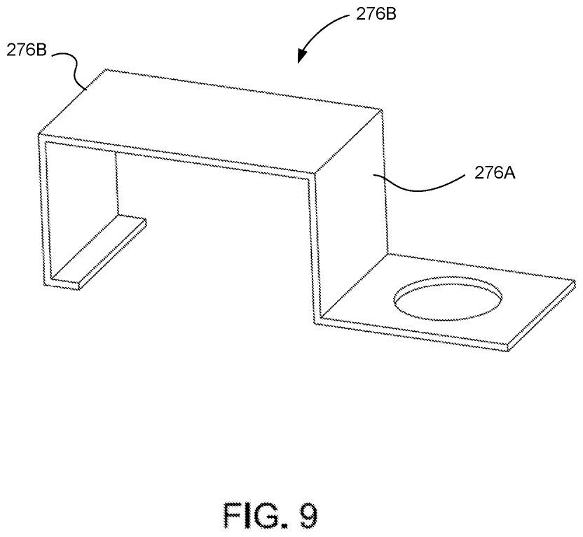

FIG. 9 is a drawing of an alternative embodiment of a bracket 200B. The bracket 200B may include all of the features of the bracket 200, with angled sections 276B and 278B in place of the radius sections 276, 278. The angled sections 276B and 278B may be square in one embodiment, but may include any angle, such as an angle that matches the shape of a cross-section of the pipe 230.

It is contemplated that multiple brackets could be used in conjunction to achieve greater holding capacity. Particularly, a pair of brackets could be used in close proximity to each other, but arranged 180° with respect to each other such that their respective flexible ends provide opposing tension, thereby forcing the pipes together from two directions rather than just one. This arrangement could be particularly useful where one or more of the pipes are bowed and additional pressure is required to maintain good touching contact.

The term pipe is used herein to mean any elongated structure such as, but not limited to a pipe, a tube, a rod, a post, and is not limited by cross-sectional shape. For example, although this application will reference standard PVC piping, solid rods, and posts having round cross-sectional shapes, squared or oval tubes, pipes, rods, etc., may also be held in place by a bracket having appropriate changes to accommodate the desired cross-sectional shape.

The elements of the figures are not exclusive. Other embodiments may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention.

What is claimed is:

1. A pipe bracket configured to hold two or more adjacent pipes in touching arrangement along a common length, the pipe bracket comprising:
a mounting arm, and
a pipe holding section defined by a stationary end, a flexible end, and a connecting member, wherein the pipe holding section is configured to hold two or more pipes in touching arrangement and under tension provided by the flexible end.

2. The pipe bracket of claim 1, wherein a length of the pipe holding section is less than the sum of the diameters of the pipes when the pipes are not present in the pipe holding section and the length is approximately equal to the sum of the diameters of the pipes when the pipes are contained in the pipe holding section, as a result of flexing of the flexible end.

3. The pipe bracket of claim 1, wherein the bracket is made of material selected from metal, plastic, rubber, or a combination thereof.

4. The pipe bracket of claim 1, wherein the pipe holding section comprises a first radius section and a second radius section connected by a flat bridge.

5. The pipe bracket of claim 1, wherein the pipe holding section defines a containment area for the two or more pipes.

6. The pipe bracket of claim 5, wherein the containment area has an oblong shape.

7. The pipe bracket of claim 1, wherein the mounting arm comprises a hole for receiving a fastener.

8. The pipe bracket of claim 7, wherein an axis of the hole is perpendicular to a longitudinal extent of the pipes and a direction in which the pipes are adjacent to each other.

9. The pipe bracket of claim 1, wherein the mounting arm extends in a plane that is parallel to a substrate and the pipe holding section is arranged to pin the pipes against the substrate.

10. The pipe bracket of claim 9, wherein the pipe holding section defines a containment area and an opening into the containment area is adjacent to the mounting arm.

11. A pipe bracket for securing a plurality of pipes to a substrate, the pipe bracket comprising:
a mounting arm comprising a hole for receiving a fastener, the mounting arm extending between a first free end and a corner;
a pipe holding section comprising a stationary end, a flexible end, and a connecting member, the pipe holding section extending from the corner to a second free at the flexible end,
wherein the connecting member includes a first radius section, a second radius section, and a flat bridge such that the pipe holding section defines a containment area having an oblong shape, and
wherein the mounting arm extends in a plane that is parallel to the substrate such that the substrate closes-off the containment area when the bracket is attached to the substrate.

12. The pipe bracket of claim 11, wherein an opening into the containment area is substantially in a same plane as the mounting arm.

13. A barrier comprising:
a first module comprising a first end pipe;
a second module comprising a second end pipe; and
a bracket configured to secure the first end pipe to the second end pipe and a substrate, the bracket comprising:
a mounting arm, and
a pipe holding section defined by a stationary end, a flexible end, and a connecting member, wherein the pipe holding section is configured to hold the first end pipe and the second end pipe in touching arrangement and under tension provided by the flexible end.

14. The barrier of claim 13, wherein the barrier is configured to be secured to the substrate by the bracket with the first and second end pipes laying on the substrate.

15. The barrier of claim 14, wherein the mounting arm extends in a plane that is parallel to the substrate such that the substrate closes-off the containment area when the bracket is attached to the substrate.

16. The barrier of claim 13, wherein the bracket is configured to be secured to the substrate by a fastener.

17. The barrier of claim 16, wherein the mounting arm comprises a hole for receiving the fastener.

18. The barrier of claim 17, wherein the fastener is a threaded fastener.

19. The barrier of claim 13, wherein the first end pipe and the second end pipe are PVC pipes.

20. The barrier of claim 19, wherein the bracket is made of material selected from metal, plastic, rubber, or a combination thereof.
